(19) United States
(12) Patent Application Publication
(10) Pub. No.: US 2021/0405485 A1
(43) Pub. Date: Dec. 30, 2021

(54) DISPLAY PANEL AND DISPLAY DEVICE

(71) Applicant: TCL CHINA STAR OPTOELECTRONICS TECHNOLOGY CO., LTD., Shenzhen, Guangdong (CN)

(72) Inventor: Yonglei ZHANG, Shenzhen, Guangdong (CN)

(21) Appl. No.: 16/641,133

(22) PCT Filed: Jan. 13, 2020
(86) PCT No.: PCT/CN2020/071636

§ 371 Date: Feb. 21, 2020

(30) Foreign Application Priority Data
Dec. 31, 2019 (CN) 201911402128.X

(51) Int. Cl. G02F 1/1362; G09G 3/36

(52) U.S. Cl. CPC G02F 1/136286; G09G 3/3688; G02F 1/136222

(57) ABSTRACT

A display panel and a display device are disclosed. The display panel includes a substrate, a plurality of data line groups located on the substrate and adjacently arranged in order, a plurality of gate line groups located on the substrate and adjacently arranged in order, and a plurality of pixel electrode array units. The pixel electrode array units include a first pixel electrode, a second pixel electrode, and a third pixel electrode. The display panel improves arrangement of the pixel electrode array units, which effectively reduces graininess on a display screen and improves viewing angles of the display screen.

### FIELD OF INVENTION

The present disclosure relates to the field of display technologies, and particularly relates to a display panel and a display device.

### BACKGROUND OF INVENTION

In continuous pursuit of high quality liquid crystal display televisions, ultra-wide viewing angles and great delicate image presentation have become a new development trend. With an increase of size and improvement of resolution of display panels, image deterioration problems incurred by a flicker phenomenon of display screens and a horizontal crosstalk phenomenon are getting more and more serious. The flicker phenomenon is a phenomenon of a display screen being suddenly bright and dark when multiple frames of images are alternated. The crosstalk phenomenon refers to when a certain region of a display image displays a certain color, areas on a left side and a right side of the region display a gray level different from a predetermined gray level. Although the industry has provided various approaches to prevent the flicker phenomenon of display screens and the horizontal crosstalk phenomenon, current solutions are usually effective in preventing only one phenomenon, that is, it is generally impossible for current display panels and display devices to simultaneously prevent the flicker phenomenon and the horizontal crosstalk phenomenon. Moreover, current solutions to the flicker phenomenon usually need to provide complicated driving signals, such as using a dot inversion driving method to drive a display panel, and this causes high power consumption of display panels.

### SUMMARY OF INVENTION

The present disclosure provides a display panel and a display device, which can effectively solve the flicker phenomenon and the horizontal crosstalk phenomenon when display images, and can effectively reduce graininess on a display screen and improve viewing angles of the display screen.

Embodiments of the present disclosure provide a display panel and a display device, which improve arrangement of the pixel electrode array units, effectively reduce graininess on a display screen, and improve viewing angles of the display screen.

An embodiment of the present disclosure provides a display panel. The display panel includes:

A substrate.

A plurality of data line groups located on the substrate and adjacently arranged in order, wherein each of the data line groups includes a plurality of data lines extending along a column direction, the data lines are used to transmit data driving signals, and polarities of the data driving signals transmitted by two adjacent data lines are opposite.

A plurality of gate line groups located on the substrate and adjacently arranged in order, wherein each of the gate line groups includes a plurality of gate lines extending along a row direction, and the gate lines are used to transmit gate driving signals.

A plurality of pixel electrode array units located on the substrate and arranged in an array manner, wherein each of the pixel electrode array units corresponds to a region encircled crossly by one of the data line groups and one of the gate line groups, a plurality of pixel electrodes of the plurality of pixel electrode array units are electrically connected to the plurality of data lines and the plurality of gate lines by a plurality of switch elements. In the plurality of pixel electrodes in a same column, polarities of the plurality of data driving signals received by two adjacent pixel electrodes are same. In the plurality of pixel electrodes in a same row, polarities of the plurality of data driving signals received by two adjacent pixel electrodes are opposite.

The pixel electrode array units include a first pixel electrode, a second pixel electrode, and a third pixel electrode, the plurality of pixel electrodes of the plurality of pixel electrode array units include a first grayscale pixel electrode, a second grayscale pixel electrode, a third grayscale pixel electrode, and a fourth grayscale pixel electrode.

Furthermore, in the plurality of pixel electrode array units, two adjacent pixel electrodes of the plurality of pixel electrodes in a same column are same pixel electrodes. The first pixel electrode, the second pixel electrode, and the third pixel electrode respectively correspond to one color filter of a blue color filter, a green color filter, and a red color filter one to one.

According to the display panel provided by an embodiment of the present disclosure, in each of the pixel electrode array units and the data line groups and the gate line groups corresponding to the pixel electrode array units, each of the data lines is electrically connected to the pixel electrodes on a right side of the data lines, and each of the gate lines is electrically connected to the pixel electrodes under the gate lines.

According to the display panel provided by an embodiment of the present disclosure, the pixel electrode array units includes:

Eight first pixel electrodes disposed in a first column, a fourth column, a seventh column, and a tenth column of a first row and in a first column, a fourth column, a seventh column, and a tenth column of a second row of the pixel electrode array units.

Eight second pixel electrodes disposed in a second column, a fifth column, an eighth column, and an eleventh column of the first row and in a second column, a fifth column, an eighth column, and an eleventh column of the second row of the pixel electrode array units.

According to the display panel provided by an embodiment of the present disclosure, the pixel electrode array units includes:

Eight third pixel electrodes disposed in a third column, a sixth column, a ninth column, and in a twelfth column of the first row and a third column, a sixth column, a ninth column, and a twelfth column of the second row of the pixel electrode array units.

According to the display panel provided by an embodiment of the present disclosure, the plurality of pixel electrode array units includes:

Six first grayscale pixel electrodes disposed in a first column, a fifth column, and a ninth column of a first row and in a third column, a seventh column, and an eleventh column of a second row of the pixel electrode array units.

Six second grayscale pixel electrodes disposed in a second column, a sixth column, and a tenth column of the first row and in a fourth column, an eighth column, and a twelfth column of the second row of the plurality of pixel electrode array units.

According to the display panel provided by an embodiment of the present disclosure, the plurality of pixel electrode array units includes:

Six third grayscale pixel electrodes disposed in a third column, a seventh column, and an eleventh column of the first row and in a first column, a fifth column, and a ninth column of the second row of the pixel electrode array units.

Six fourth grayscale pixel electrodes disposed in a fourth column, an eighth column, and a twelfth column of the first row and in a second column, a sixth column, and a tenth column of the second row of the pixel electrode array units.

According to the display panel provided by an embodiment of the present disclosure, grayscale values of the first grayscale pixel electrode, the second grayscale pixel electrode, the third grayscale pixel electrode, and the fourth grayscale pixel electrode are:

the second grayscale pixel electrode>the first grayscale pixel electrode>the third grayscale pixel electrode>the fourth grayscale pixel electrode.

An embodiment of the present disclosure further provides a display panel, and the display panel includes:

A substrate.

A plurality of data line groups located on the substrate and adjacently arranged in order, wherein each of the data line groups includes a plurality of data lines extending along a column direction, the data lines are used to transmit data driving signals, and polarities of the data driving signals transmitted by two adjacent data lines are opposite.

A plurality of gate line groups located on the substrate and adjacently arranged in order, wherein each of the gate line groups includes a plurality of gate lines extending along a row direction, and the gate lines are used to transmit a gate driving signals,

A plurality of pixel electrode array units located on the substrate and arranged in an array manner, wherein each of the pixel electrode array units corresponds to a region encircled crossly by one of the data line groups and one of the gate line groups, pixel electrodes of the plurality of pixel electrode array units are electrically connected to the data lines and the gate lines by switch elements; in the pixel electrodes in a same column, polarities of the data driving signals received by two adjacent pixel electrodes are same, and in the pixel electrodes in a same row, polarities of the data driving signals received by two adjacent pixel electrodes are opposite,

The pixel electrode array units include a first pixel electrode, a second pixel electrode, and a third pixel electrode. The pixel electrodes of pixel electrode array units include a first grayscale pixel electrode, a second grayscale pixel electrode, a third grayscale pixel electrode, and a fourth grayscale pixel electrode.

According to the display panel provided by an embodiment of the present disclosure, in each of the pixel electrode array units and the data line groups and the gate line groups corresponding to the pixel electrode array units, each of the data lines is electrically connected to the pixel electrodes on a right side of the data lines, and each of the gate lines is electrically connected to the pixel electrodes under the gate lines.

According to the display panel provided by an embodiment of the present disclosure, in the pixel electrode array units, two adjacent pixel electrodes of the pixel electrodes in a same column are same pixel electrodes.

According to the display pan& provided by an embodiment of the present disclosure, the first pixel electrode, the second pixel electrode, and the third pixel electrode respectively correspond to one color filter of a blue color filter, a green color filter, and a red color filter one to one,

According to the display panel provided by an embodiment of the present disclosure, the plurality of pixel electrode array units includes:

Eight first pixel electrodes disposed in a first column, a fourth column, a seventh column, and a tenth column of a first row and in a first column, a fourth column, a seventh column, and a tenth column of a second row of the pixel electrode array units.

Eight second pixel electrodes disposed in a second column, a fifth column, an eighth column, and an eleventh column of the first row and in a second column, a fifth column, an eighth column, and an eleventh column of the second row of the pixel electrode array units.

According to the display panel provided by an embodiment of the present disclosure, the plurality of pixel electrode array units includes:

Eight third pixel electrodes disposed in a third column, a sixth column, a ninth column, and a twelfth column of the first row and in a third column, a sixth column, a ninth column, and a twelfth column of the second row of the pixel electrode array units.

According to the display panel provided by an embodiment of the present disclosure, the plurality of pixel electrode array units includes:

Six first grayscale pixel electrodes disposed in a first column, a fifth column, and a ninth column of a first row and in a third column, a seventh column, and an eleventh column of a second row of the pixel electrode array units.

Six fourth grayscale pixel electrodes disposed in a second column, a sixth column, and a tenth column of the first row and in a fourth column, an eighth column, and a twelfth column of the second row of the pixel electrode array units.

According to the display panel provided by an embodiment of the present disclosure, the plurality of pixel electrode array units includes:

Six third grayscale pixel electrodes disposed in a third column, a seventh column, and an eleventh column of the first row and in a first column, a fifth column, and a ninth column of the second row of the pixel electrode array units.

Six fourth grayscale pixel electrodes disposed in a fourth column, an eighth column, and a twelfth column of the first row and in a second column, a sixth column, and a tenth column of the second row of the pixel electrode array units.

According to the display panel provided by an embodiment of the present disclosure, grayscale values of the first grayscale pixel electrode, the second grayscale pixel electrode, the third grayscale pixel electrode, and the fourth grayscale pixel electrode are:

the second grayscale pixel electrode>the first grayscale pixel electrode>the third grayscale pixel electrode>the fourth grayscale pixel electrode.

An embodiment of the present disclosure further provides a display device, and the display device further includes a display panel.

Furthermore, the display panel includes:

A substrate.

A plurality of data line groups located on the substrate and adjacently arranged in order, wherein each of the data line groups includes a plurality of data lines extending along a column direction, the data lines are used to transmit data driving signals, and polarities of the data driving signals transmitted by two adjacent data lines are opposite,

A plurality of gate line groups located on the substrate and adjacently arranged in order, wherein each of the gate line groups includes a plurality of gate lines extending along a row direction, and the gate lines are used to transmit a gate driving signals..

A plurality of pixel electrode array units located on the substrate and arranged in an array manner, wherein each of the pixel electrode array units corresponds to a region encircled crossly by one of the data line groups and one of the gate line groups, pixel electrodes of the pixel electrode array units are electrically connected to the data lines and the gate lines by switch elements. In the pixel electrodes in a same column, polarities of the plurality of data driving signals received by two adjacent pixel electrodes are same. In the pixel electrodes in a same row, polarities of the data driving signals received by two adjacent pixel electrodes are opposite.

The pixel electrode array units include a first pixel electrode, a second pixel electrode, and a third pixel electrode. The pixel electrodes of pixel electrode array units include a first grayscale pixel electrode, a second grayscale pixel electrode, a third grayscale pixel electrode, and a fourth grayscale pixel electrode.

In the display panel provided by the present disclosure, polarities of the plurality of data driving signals received by two adjacent pixel electrodes being same in the pixel electrodes in a same column and polarities received by two adjacent pixel electrodes being opposite in the pixel electrodes in a same row can be realized by rearranged pixel electrode array units and by correspondingly connecting each of the pixel electrodes of the pixel electrode array units to corresponding data lines and corresponding gate lines to make polarities provided by adjacent data lines be opposite. . Therefore, the flicker phenomenon and the horizontal crosstalk phenomenon can be prevented during display. Moreover, the display panel further has an advantage of low power consumption due to the fact that complicated driving signals are not needed. Furthermore, by disposing different grayscale pixel electrodes, side viewing angles of the display panel can be close to front viewing angles, and the grayscale pixel electrodes with different sizes can reduce graininess of the display panel.

The display device provided by the present disclosure has the display panel provided by the present disclosure, so the display device can prevent the flicker phenomenon and the horizontal crosstalk phenomenon during display, has an advantage of low power consumption, can further reduce graininess on the display screen, and improves viewing angles of display screens.

### DESCRIPTION OF DRAWINGS

The technical solutions and other advantageous effects of the present invention will be apparent with reference to the following accompanying drawings and detailed description of embodiments of the present disclosure.

FIG. 1 is one pixel electrode array unit in a display panel provided by an embodiment.

### DETAILED DESCRIPTION OF PREFERRED EMBODIMENTS

The technical solutions in the embodiments of the present disclosure are clearly and completely described in the following with reference to the accompanying drawings in the embodiments of the present disclosure. Obviously, the described embodiments are only part of the embodiments of the present disclosure, but are not all embodiments of the present disclosure. Ail other embodiments obtained by those skilled in the art based on the embodiments of the present disclosure without creative efforts are within the scope of the present disclosure.

In the description of the present disclosure, it is to be understood that the orientation or positional relationship indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise” etc. is based on the orientation or positional relationship shown in the accompanying figures, which is merely for the convenience for describing of the present disclosure and for the simplification of the description, and is not intended to indicate or imply that the indicated devices or elements have a specific orientation or is constructed and operated in a specific orientation. Therefore, it should not be understood as a limitation on the present disclosure. Moreover, the terms “first” and “second” are used for descriptive purposes only and are not to be understood as indicating or implying relative importance or implicitly indicating the number of the indicated technical characteristics. Therefore, the characteristics defined by “first” or “second” may include one or more of the described characteristics either explicitly or implicitly. In the description of the present disclosure, the meaning of “a plurality” is two or more unless clearly and specifically defined otherwise.

In the description of the present disclosure, unless specified or limited otherwise, terms “mounted,” “connected,” “coupled,” and the like are used in a broad sense, and may include, for example, fixed connections, detachable connections, or integral connections; may also be mechanical or electrical connections or may be communication between each other; may also be direct connections or indirect connections via intervening structures; may also be inner communications of two elements or may be a relationship of interaction between two elements. For persons skilled in the art in this field, the specific meanings of the above terms in the present disclosure can be understood with specific cases.

In the present disclosure, unless expressly specified or limited otherwise, a first feature is “on” or “beneath” a second feature may include that the first feature directly contacts the second feature and may also include that the first feature does not directly contact the second feature. Furthermore, a first feature “on,” “above,” or “on top of” a second feature may include an embodiment in which the first feature is right “on,” “above,” or “on top of” the second feature and may also include that the first feature is not right “on,” “above,” or “on top of” the second feature, or just means that the first feature has a sea level elevation higher than the sea level elevation of the second feature. While first feature “beneath,” “below,” or “on bottom of” a second feature may include that the first feature is “beneath,” “below,” or “on bottom of” the second feature and may also include that the first feature is not right “beneath,” “below,” or “on bottom of” the second feature, or just means that the first feature has a sea level elevation lower than the sea level elevation of the second feature.

The following disclosure provides many different embodiments or examples for implementing the different structures of the present disclosure. In order to simplify the disclosure of the present disclosure, the components and configurations of the specific examples are described below. Of course, they are merely examples and are not intended to limit the present disclosure. In addition, the present disclosure may repeat reference numerals and/or reference numerals in different examples, which are for the purpose of simplicity and clarity, and do not indicate the relationship between the various embodiments and/or arrangements discussed. Moreover, the present disclosure provides embodiments of various specific processes and materials, but one of ordinary skill in the art will recognize the use of other processes and/or the use of other materials.

An embodiment of the present disclosure firstly provides a display panel. The display panel includes a substrate, a plurality of data line groups located on the substrate and adjacently arranged in order, and a plurality of gate line groups located on the substrate and adjacently arranged in order. Each of the data line groups includes a plurality of data lines extending along a column direction, and the data lines are used to transmit data driving signals. Each of the gate line groups includes a plurality of gate lines extending along a row direction, and the gate lines are used to transmit gate driving signals. The display panel further includes a plurality of pixel electrode array units located on the substrate and arranged in an array manner. Each of the pixel electrode array units corresponds to a region encircled crossly by one of the data line groups and one of the gate line groups. Pixel electrodes of the pixel electrode array units are electrically connected to the data lines and the gate lines by switch elements. In the pixel electrodes in a same column, polarities of data driving signals received by two adjacent pixel electrodes are same. In the pixel electrodes in a same row, polarities of data driving signals received by two adjacent pixel electrodes are opposite.

The pixel electrode array units include a first pixel electrode, a second pixel electrode, and a third pixel electrode. The pixel electrodes of pixel electrode array units include a first grayscale pixel electrode, a second grayscale pixel electrode, a third grayscale pixel electrode, and a fourth grayscale pixel electrode.

It should be noted that the row direction and the column direction of this embodiment are relative, that is, any direction in a plane can be defined as the row direction, and a direction perpendicular to the row direction can be defined as the column direction.

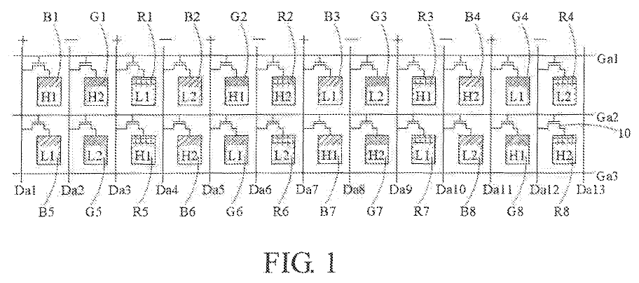

Please refer to FIG. 1. FIG. 1 shows one of the pixel electrode array units of the display panel provided by this embodiment. The pixel electrode array unit includes three kinds of pixel electrodes, which are respectively a first pixel electrode, a second pixel electrode, and a third pixel electrode. The first pixel electrode, the second pixel electrode, and the third pixel electrode respectively correspond to one color filter of a blue color filter, a green color filter, and a red color filter one to one. In this embodiment , the first pixel electrode corresponds to the blue color filter, the second pixel electrode corresponds to the green color filter, and the third pixel electrode corresponds to the red color filter. Of course, the three kinds of pixel electrodes can correspond to different color filters according to different design requirements. For example, they can correspond to color filters partially or completely, and may also corresponds to color filters with colors different from each other. In FIG. 1, each of the pixel electrodes includes eight pixel electrodes, and one of the pixel electrode array units includes twenty-four pixel electrodes. Specifically, in FIG. 1, the same pixel electrodes are indicated by same patterns. In the three kinds of pixel electrodes, the first pixel electrode includes a first pixel electrode B1, a first pixel electrode B2, a first pixel electrode B3, a first pixel electrode B4, a first pixel electrode B5, a first pixel electrode B6, a first pixel electrode B7, and a first pixel electrode B8. The second pixel electrode includes a second pixel electrode G1, a second pixel electrode G2, a second pixel electrode G3, a second pixel electrode G4, a second pixel electrode G5, a second pixel electrode G6, a second pixel electrode G7, and a second pixel electrode G8. The third pixel electrode includes a third pixel electrode R1, a third pixel electrode R2, a third pixel electrode R3, a third pixel electrode R4, a third pixel electrode R5, a third pixel electrode R6, a third pixel electrode R7, and a third pixel electrode R8.

The twenty-four pixel electrodes of the pixel electrode array units are arranged in a matrix with twelve columns times two rows. Specifically, in the eight first pixel electrodes, the first pixel electrode B1 is disposed in a first column of a first row of the pixel electrode array units, the first pixel electrode B2 is disposed in a fourth column of the first row of the pixel electrode array units, the first pixel electrode B3 is disposed in a seventh column of the first row of the pixel electrode array units, the first pixel electrode B4 is disposed in a tenth column of the first row of the pixel electrode array units, the first pixel electrode B5 is disposed in a first column of a second row of the pixel electrode array units, the first pixel electrode B6 is disposed in a fourth column of the second row of the pixel electrode array units, the first pixel electrode B7 is disposed in a seventh column of the second row of the pixel electrode array units, and the first pixel electrode B8 is disposed in a tenth column of the second row of the pixel electrode array units. In the eight second pixel electrodes, the second pixel electrode G1 is disposed in a second column of the first row of the pixel electrode array units, the second pixel electrode G2 is disposed in a fifth column of the first row of the pixel electrode array units, the second pixel electrode G3 is disposed in an eighth column of the first row of the pixel electrode array units, the second pixel electrode G4 is disposed in an eleventh column of the first row of the pixel electrode array units, the second pixel electrode G5 is disposed in a second column of the second row of the pixel electrode array units, the second pixel electrode G6 is disposed in a fifth column of the second row of the pixel electrode array units, the second pixel electrode G7 is disposed in an eighth column of the second row of the pixel electrode array units, and the second pixel electrode G8 is disposed in an eleventh column of the second row of the pixel electrode array units. In the eight third pixel electrodes, the third pixel electrode R1 is disposed in a third column of the first row of the pixel electrode array units, the third pixel electrode R2 is disposed in a sixth column of the first row of the pixel electrode array units, the third pixel electrode R3 is disposed in a ninth column of the first row of the pixel electrode array units, the third pixel electrode R4 is disposed in a twelfth column of the first row of the pixel electrode array units, the third pixel electrode R5 is disposed in a third column of the second row of the pixel electrode array units, the third pixel electrode R6 is disposed in a sixth column of the second row of the pixel electrode array units, the third pixel electrode R7 is disposed in a ninth column of the second row of the pixel electrode array units, and the third pixel electrode R8 is disposed in a twelfth column of the second row of the pixel electrode array units.

Viewing the above-mentioned pixel electrodes arranged in the matrix from the row direction, the twelve pixel electrodes in the first row from left to right are the first pixel electrode B1, the second pixel electrode G1, the third pixel electrode R1, the first pixel electrode B2, the second pixel electrode G2, the third pixel electrode R2, the first pixel electrode B3, the second pixel electrode G3, the third pixel electrode R3, the first pixel electrode B4, the second pixel electrode G4, and the third pixel electrode R4; and the twelve pixel electrodes in the second row from left to right are the first pixel electrode B5, the second pixel electrode G5, the third pixel electrode R5, the first pixel electrode B6, the second pixel electrode G6, the third pixel electrode R6, the first pixel electrode B7, the second pixel electrode G7, the third pixel electrode R7, the first pixel electrode B8, the second pixel electrode G8, and the third pixel electrode R8. That is, in the pixel electrode array units, the two adjacent pixel electrodes in a same column of the pixel electrodes are same pixel electrodes.

The pixel electrodes of the pixel electrode array units include a first grayscale pixel electrode H1, a second grayscale pixel electrode H2, a third grayscale pixel electrode L1, and a fourth grayscale pixel electrode L2. Furthermore, grayscale values of the first grayscale pixel electrode, the second grayscale pixel electrode, the third grayscale pixel electrode, and the fourth grayscale pixel electrode are

the second grayscale pixel electrode>the first grayscale pixel electrode>the third grayscale pixel electrode>the fourth grayscale pixel electrode.

The twenty-four pixel electrodes of the pixel electrode array units are arranged in a matrix with twelve columns times two rows. Specifically, in the pixel electrodes of the first row, the pixel electrodes from left to right are respectively the first grayscale pixel electrode H1, the second grayscale pixel electrode H2, the third grayscale pixel electrode L1, the fourth grayscale pixel electrode L2, the first grayscale pixel electrode H1, the second grayscale pixel electrode H2, the third grayscale pixel electrode L1, the fourth grayscale pixel electrode L2, the first grayscale pixel electrode H1, the second grayscale pixel electrode H2, the third grayscale pixel electrode L1, and the fourth grayscale pixel electrode L2. In the pixel electrodes of the second row, the pixel electrodes from left to right are respectively the third grayscale pixel electrode L1, the fourth grayscale pixel electrode L2, the first grayscale pixel electrode H1, the second grayscale pixel electrode H2, the third grayscale pixel electrode L1, the fourth grayscale pixel electrode L2, the first grayscale pixel electrode H1, the second grayscale pixel electrode H2, the third grayscale pixel electrode L1, the fourth grayscale pixel electrode L2, the first grayscale pixel electrode H1, and the second grayscale pixel electrode H2.

Specifically, in the first row, the first pixel electrode B1 is the first grayscale pixel electrode H1, the second pixel electrode G1 is the second grayscale pixel electrode H2, the third pixel electrode R1 is the third grayscale pixel electrode L1, the first pixel electrode B2 is the fourth grayscale pixel electrode L2, the second pixel electrode G2 is the first grayscale pixel electrode H1, the third pixel electrode R2 is the second grayscale pixel electrode H2, the first pixel electrode B3 is the third grayscale pixel electrode L1, the second pixel electrode G3 is the fourth grayscale pixel electrode L2, the third pixel electrode R3 is the first grayscale pixel electrode H1, the first pixel electrode B4 is the second grayscale pixel electrode H2, the second pixel electrode G4 is the third grayscale pixel electrode L1, and the third pixel electrode R4 is the fourth grayscale pixel electrode L2. In the second row, the first pixel electrode B5 is the third grayscale pixel electrode L1, the second pixel electrode G5 is the fourth grayscale pixel electrode L2, the third pixel electrode R5 is the first grayscale pixel electrode H1, the first pixel electrode B6 is the second grayscale pixel electrode H2, the second pixel electrode G6 is the third grayscale pixel electrode Li, the third pixel electrode R6 is the fourth grayscale pixel electrode L2, the first pixel electrode B7 is the first grayscale pixel electrode H1, the second pixel electrode G7 is the second grayscale pixel electrode H2, the third pixel electrode R7 is the third grayscale pixel electrode L1, the first pixel electrode B8 is the fourth grayscale pixel electrode L2, the second pixel electrode G8 is the first grayscale pixel electrode H1, and the third pixel electrode R8 is the second grayscale pixel electrode H2.

The twenty-four pixel electrodes of the pixel electrode array units are electrically connected to the corresponding data lines and the corresponding gate lines by switch elements 10, thereby allowing the pixel electrodes to receive corresponding data driving signals and corresponding gate driving signals. Furthermore, the switch elements 10 are field effect transistors, such as thin film transistors (TFTs), etc., and can be other switch elements. For easy reading, only one of the switch elements 10 is marked in FIG. 1.

Please refer to FIG. 1. The pixel electrode array units of this embodiment are located on regions encircled crossly by the data line Da1 to the data line Da13 and the gate line Ga1 to the gate line Ga3. From this, it can be understood that the data line Da1 to the data line Da13 is one data line group, and the gate line Gal to the gate line Ga3 is one gate line group. However, in this embodiment, a number of data lines included by one data line group is not thirteen but twelve, that is, the data line Da1 to the data line Da12. One gate line group includes two gate lines, which are the gate line Ga1 to gate line Gat.

In the pixel electrode array units of this embodiment and the corresponding data line groups and the gate line groups thereof, each of the data lines is electrically connected to the pixel electrodes on a right side of the data lines, and each of the gate lines is electrically connected to the pixel electrodes under the gate lines. That is, each of the pixel electrode is simultaneously connected to one corresponding data line and one corresponding gate line by one corresponding switch element 10. Preferably, when the switch elements 10 are TFTs, source electrodes of the TFTs are electrically connected to corresponding data lines, drain electrodes of the TFTs are electrically connected to the pixel electrodes, and the gate electrodes of the TFTs are electrically connected to corresponding gate lines. Based on the above, all of the thirty-two pixel electrodes of the pixel electrode array units constitute electrical connection structures with the data line Da1 to the data line Da12 and the gate line Ga1 to the gate line Ga2.

From the arrangement of each of the pixel electrodes of the pixel electrode array units of this embodiment and the electrical connection of each pixel electrode, the data lines and the gate lines, it can be understood that as long as the polarities of the data signals transmitted by two adjacent data lines are reversed, having same polarities of the data driving signals received by two adjacent pixel electrodes in a same column and opposite polarities of the data driving signals received by two adjacent same kind pixel electrodes in a same row can be realized.

Specifically, please refer to FIG, 1. A positive sign (+) and a negative sign (−) located in the pixel electrodes of this embodiment are used to indicate the polarities of the data driving signals received by the pixel electrodes at the time shown in FIG. 1. The positive sign (+) indicates that the data driving signal received by the pixel electrode is in a positive polarity, and the negative sign (−) indicates that the data driving signal received by the pixel electrode is in a negative polarity.

In the time shown in FIG. 1, the data signals transmitted by the data line Da1, the data line Da3, the data line Da5, the data line Da7, the data line Da9, and the data line Da11 are made to be in positive polarities, while the data signals transmitted by the data line Da2, the data line Da4, the data line Da6, the data line Da6, the data line Da10, and the data line Da12 are made to be in negative polarities. Then, the data driving signals received by the first pixel electrode B1, the third pixel electrode R1, the second pixel electrode G2, the first pixel electrode B3, the third pixel electrode R3, the second pixel electrode G4, the first pixel electrode B5, the third pixel electrode R5, the second pixel electrode G6, the first pixel electrode B7, the third pixel electrode R7, and the second pixel electrode G8 are in positive polarities, while the data driving signals received by the second pixel electrode G1, the first pixel electrode B2, the third pixel electrode R2, the second pixel electrode G3, the first pixel electrode B4, the third pixel electrode R4, the second pixel electrode G5, the first pixel electrode B6, the third pixel electrode R6, the second pixel electrode G7, the first pixel electrode B8, and the third pixel electrode R8 are in negative polarities. It should be noted that, at this time, polarities of the data driving signals received by the two adjacent same kind pixel electrodes in an arbitrary column are same. For example, the data signal received by the first pixel electrode B1 is in a positive polarity, and the data signal received by the first pixel electrode B5 is in a positive polarity. However, at this time, polarities of the data driving signals received by the two adjacent same kind pixel electrodes in an arbitrary column are opposite. For example, in the first row, the data signal received by the first pixel electrode B1 is in a positive polarity, and the data signal received by the second pixel electrode G1 is in a negative polarity. Similarly, in another situation that is not shown in the figure, the data signals transmitted by the data line Da1, the data line Da3, the data line Da5, the data line Da7, the data line Da9, and the data line Da11 are made to be in negative polarities, while the data signals transmitted by the data line Da2, the data line Da4, the data line Da6, the data line Da6, the data line Da10, and the data line Da12 are made to be in positive electrode polarities. Then, all data driving signals received by the twenty-four pixel electrodes are reversed. The pixel electrodes originally receiving the positive data driving signals change to receive the negative data driving signals, and the pixel electrodes originally receiving the negative data driving signals change to receive the positive data driving signals. At this time, data driving signals received by the two adjacent pixel electrodes in a same column still have same polarities, and polarities of the data driving signals received by the two adjacent same kind pixel electrodes in a same row are opposite.

In a liquid crystal display panel, in order to prevent abnormal orientation of liquid crystals from occurring incurred by staying in the same electric field for a long time, when the display is set to display two frames of consecutive images, the polarities of the data driving signals received by the same pixel electrode are different. For example, when displaying a first frame image, the data driving signal received by one pixel electrode is in a positive polarity, and when displaying a second frame image, the data driving signal received by one pixel electrode is in a negative polarity. Subsequent display processes repeat the process. It can be understood that when displaying any frame of images, the data driving signals received by all pixel electrodes are in positive polarities, and when displaying an image of next frame, the data driving signals received by all pixel electrodes are in negative polarities. Although a corresponding controller is set to have same electric level of voltage of the data driving signals with the positive polarity and the negative polarity, due to reasons such as capacitive coupling, etc. between the pixel electrodes and common electrodes on a color filter plate, the electric level of voltage of the data driving signals with the positive polarity and the negative polarity will deviate to a same polarity. For example, both will deviate to the negative polarity. Therefore, when the data driving signals received by all pixel electrodes are in positive polarities, the displayed images are relatively dark, and when the data driving signals received by all pixel electrodes are in negative polarities, the displayed images are relatively bright, so under the fast update of different images on a screen, the flicker phenomenon occurs on the liquid crystal display panel. When two adjacent same kind pixel electrodes of the same row receive the data driving signals with the same polarities, sharp pulses will be induced between different data lines, thereby resulting in the horizontal crosstalk phenomenon. However, in this embodiment, polarities of the data driving signals received by two adjacent same kind pixel electrodes in a same row are opposite, so it is possible for the liquid crystal display panel provided by this embodiment to prevent the horizontal crosstalk phenomenon. Meanwhile, because a complicated driving method is not applied, the power consumption is low. In summary, the display panel provided by the present disclosure can simultaneously prevent the flicker phenomenon and the horizontal crosstalk phenomenon, and the power consumption is low. Furthermore, by disposing different grayscale pixel electrodes, side viewing angles of the display panel can be close to front viewing angles, and the grayscale pixel electrodes with different sizes can reduce graininess of the display panel.

An embodiment of the present disclosure further provides a display device. The display device includes the display panel provided by the embodiments of the present disclosure mentioned above, and the display device can further include structures such as a backlight source, or an encapsulation outer frame, etc. Because the display device provided by this embodiment has the display panel provided by the embodiments of the present disclosure mentioned above, when the display device is displaying images, it can prevent the flicker phenomenon and the horizontal crosstalk phenomenon, and comparing it to current dot inversion driving modes, it has lower power consumption. Furthermore, by disposing different grayscale pixel electrodes, side viewing angles of the display panel can be close to front viewing angles, and the grayscale pixel electrodes with different sizes can reduce graininess of the display panel.

The embodiments of present disclosure are described in detail above. This article uses specific cases for describing the principles and the embodiments of the present disclosure, and the description of the embodiments mentioned above is only for helping to understand the method and the core idea of the present disclosure. It should be understood by those skilled in the art, that it can perform changes in the technical solution of the embodiments mentioned above, or can perform equivalent replacements in part of technical characteristics, and the changes or replacements do not make the essence of the corresponding technical solution depart from the scope of the technical solution of each embodiment of the present disclosure.

What is claimed is:

1. A display panel, comprising:
a substrate;
a plurality of data line groups located on the substrate and adjacently arranged in order, wherein each of the data line groups comprises a plurality of data lines extending along a column direction, the plurality of data lines are used to transmit a plurality of data driving signals, and polarities of the plurality of data driving signals transmitted by two adjacent data lines are opposite;
a plurality of gate line groups located on the substrate and adjacently arranged in order, wherein each of the plurality of gate line groups comprises a plurality of gate lines extending along a row direction, and the plurality of gate lines are used to transmit a plurality of gate driving signals; and
a plurality of pixel electrode array units located on the substrate and arranged in an array manner, wherein each of the pixel electrode array units corresponds to a region encircled crossly by one of the data line groups and one of the gate line groups, a plurality of pixel electrodes of the plurality of pixel electrode array units are electrically connected to the plurality of data lines and the plurality of gate lines by a plurality of switch elements, in the plurality of pixel electrodes in a same column, polarities of the plurality of data driving signals received by two adjacent pixel electrodes are same, and in the plurality of pixel electrodes in a same row, polarities of the plurality of data driving signals received by two adjacent pixel electrodes are opposite,
wherein the plurality of pixel electrode array units comprise a first pixel electrode, a second pixel electrode, and a third pixel electrode, and the plurality of pixel electrodes of the plurality of pixel electrode array units comprise a first grayscale pixel electrode, a second grayscale pixel electrode, a third grayscale pixel electrode, and a fourth grayscale pixel electrode;
wherein in the plurality of pixel electrode array units, two adjacent pixel electrodes of the plurality of pixel electrodes in a same column are same pixel electrodes, and the first pixel electrode, the second pixel electrode, and the third pixel electrode respectively correspond to one color filter of a blue color filter, a green color filter, and a red color filter one to one.

2. The display panel as claimed in claim 1, wherein in each of the plurality of pixel electrode array units and the plurality of data line groups and the plurality of gate line groups corresponding to the plurality of pixel electrode array units, each of the plurality of data lines is electrically connected to the plurality of pixel electrodes on a right side of the plurality of data lines, and each of the plurality of gate lines is electrically connected to the plurality of pixel electrodes under the plurality of gate lines.

3. The display panel as claimed in claim 1, wherein the plurality of pixel electrode array units comprise:
eight first pixel electrodes disposed in a first column, a fourth column, a seventh column, and a tenth column of a first row and in a first column, a fourth column, a seventh column, and a tenth column of a second row of the plurality of pixel electrode array units; and
eight second pixel electrodes disposed in a second column, a fifth column, an eighth column, and an eleventh column of the first row and in a second column, a fifth column, an eighth column, and an eleventh column of the second row of the plurality of pixel electrode array units.

4. The display panel as claimed in claim 3, wherein the plurality of pixel electrode array units comprise:
eight third pixel electrodes disposed in a third column, a sixth column, a ninth column, and a twelfth column of the first row and in a third column, a sixth column, a ninth column, and a twelfth column of the second row of the plurality of pixel electrode array units,

5. The display panel as claimed in claim 1, wherein the plurality of pixel electrode array units comprise:
six first grayscale pixel electrodes disposed in a first column, a fifth column, and a ninth column of a first row and in a third column, a seventh column, and an eleventh column of a second row of the plurality of pixel electrode array units; and
six second grayscale pixel electrodes disposed in a second column, a sixth column, and a tenth column of the first row and in a fourth column, an eighth column, and a twelfth column of the second row of the plurality of pixel electrode array units.

6. The display panel as claimed in claim 5, wherein the plurality of pixel electrode array units comprise:
six third grayscale pixel electrodes disposed in a third column, a seventh column, and an eleventh column of the first row and in a first column, a fifth column, and a ninth column of the second row of the plurality of pixel electrode array units; and
six fourth grayscale pixel electrodes disposed in a fourth column, an eighth column, and a twelfth column of the first row and in a second column, a sixth column, and a tenth column of the second row of the plurality of pixel electrode array units.

7. The display panel as claimed in claim 1, wherein grayscale values of the first grayscale pixel electrode, the second grayscale pixel electrode, the third grayscale pixel electrode, and the fourth grayscale pixel electrode are:
the second grayscale pixel electrode>the first grayscale pixel electrode>the third grayscale pixel electrode>the fourth grayscale pixel electrode,

8. A display panel, comprising:
a substrate;
a plurality of data line groups located on the substrate and adjacently arranged in order, wherein each of the data line groups comprises a plurality of data lines extending along a column direction, the plurality of data lines are used to transmit a plurality of data driving signals, and polarities of the plurality of data driving signals transmitted by two adjacent data lines are opposite;
a plurality of gate line groups located on the substrate and adjacently arranged in order, wherein each of the plurality of gate line groups comprises a plurality of gate lines extending along a row direction, and the plurality of gate lines are used to transmit a plurality of gate driving signals; and
a plurality of pixel electrode array units located on the substrate and arranged in an array manner, wherein each of the pixel electrode array units corresponds to a region encircled crossly by one of the data line groups and one of the gate line groups, a plurality of pixel electrodes of the plurality of pixel electrode array units are electrically connected to the plurality of data lines and the plurality of gate lines by a plurality of switch elements, in the plurality of pixel electrodes in a same column, polarities of the plurality of data driving signals received by two adjacent pixel electrodes are same, and in the plurality of pixel electrodes in a same row, polarities of the plurality of data driving signals received by two adjacent pixel electrodes are opposite,
wherein the plurality of pixel electrode array units comprise a first pixel electrode, a second pixel electrode, and a third pixel electrode, and the plurality of pixel electrodes of the plurality of pixel electrode array units comprise a first grayscale pixel electrode, a second grayscale pixel electrode, a third grayscale pixel electrode, and a fourth grayscale pixel electrode.

9. The display panel as claimed in claim 8, wherein in each of the plurality of pixel electrode array units and the plurality of data line groups and the plurality of gate line groups corresponding to the plurality of pixel electrode array units, each of the plurality of data lines is electrically connected to the plurality of pixel electrodes on a right side of the plurality of data lines, and each of the plurality of gate lines is electrically connected to the plurality of pixel electrodes under the plurality of gate lines.

10. The display panel as claimed in claim 8, wherein in the plurality of pixel electrode array units, two adjacent pixel electrodes of the plurality of pixel electrodes in a same column are same pixel electrodes.

11. The display panel as claimed in claim 8, wherein the first pixel electrode, the second pixel electrode, and the third pixel electrode respectively correspond to one color filter of a blue color filter, a green color filter, and a red color filter one to one.

12. The display panel as claimed in claim 8, wherein the plurality of pixel electrode array units comprise:
eight first pixel electrodes disposed in a first column, a fourth column, a seventh column, and a tenth column of a first row and in a first column, a fourth column, a seventh column, and a tenth column of a second row of the plurality of pixel electrode array units; and
eight second pixel electrodes disposed in a second column, a fifth column, an eighth column, and an eleventh column of the first row and in a second column, a fifth column, an eighth column, and an eleventh column of the second row of the plurality of pixel electrode array units.

13. The display panel as claimed in claim 12, wherein the plurality of pixel electrode array units comprise:
eight third pixel electrodes disposed in a third column, a sixth column, a ninth column, and in a twelfth column of the first row and a third column, a sixth column, a ninth column, and a twelfth column of the second row of the plurality of pixel electrode array units.

14. The display panel as claimed in claim 8, wherein the plurality of pixel electrode array units comprise:
six first grayscale pixel electrodes disposed in a first column, a fifth column, and in a ninth column of a first row and a third column, a seventh column, and an eleventh column of a second row of the plurality of pixel electrode array units; and
six second grayscale pixel electrodes disposed in a second column, a sixth column, and a tenth column of the first row and a fourth column, an eighth column, and in a twelfth column of the second row of the plurality of pixel electrode array units.

15. The display panel as claimed in claim 14, wherein the plurality of pixel electrode array units comprise:
six third grayscale pixel electrodes disposed in a third column, a seventh column, and in an eleventh column of the first row and a first column, a fifth column, and a ninth column of the second row of the plurality of pixel electrode array units; and
six fourth grayscale pixel electrodes disposed in a fourth column, an eighth column, and a twelfth column of the first row and in a second column, a sixth column, and a tenth column of the second row of the plurality of pixel electrode array units.

16. The display panel as claimed in claim 8, wherein grayscale values of the first grayscale pixel electrode, the second grayscale pixel electrode, the third grayscale pixel electrode, and the fourth grayscale pixel electrode are:
the second grayscale pixel electrode>the first grayscale pixel electrode>the third grayscale pixel electrode>the fourth grayscale pixel electrode.

17. A display device, comprising a display panel,
wherein the display panel comprises:
a substrate;
a plurality of data line groups located on the substrate and adjacently arranged in order, wherein each of the data line groups comprises a plurality of data lines extending along a column direction, the plurality of data lines are used to transmit a plurality of data driving signals, and polarities of the plurality of data driving signals transmitted by two adjacent data lines are opposite;
a plurality of gate line groups located on the substrate and adjacently arranged in order, wherein each of the plurality of gate line groups comprises a plurality of gate lines extending along a row direction, and the plurality of gate lines are used to transmit a plurality of gate driving signals; and
a plurality of pixel electrode array units located on the substrate and arranged in an array manner, wherein each of the pixel electrode array units corresponds to a region encircled crossly by one of the data line groups and one of the gate line groups, a plurality of pixel electrodes of the plurality of pixel electrode array units are electrically connected to the plurality of data lines and the plurality of gate lines by a plurality of switch elements, in the plurality of pixel electrodes in a same column, polarities of the plurality of data driving signals received by two adjacent pixel electrodes are same, and in the plurality of pixel electrodes in a same row, polarities of the plurality of data driving signals received by two adjacent pixel electrodes are opposite,
wherein the plurality of pixel electrode array units comprise a first pixel electrode, a second pixel electrode, and a third pixel electrode, and the plurality of pixel electrodes of the plurality of pixel electrode array units comprise a first grayscale pixel electrode, a second grayscale pixel electrode, a third grayscale pixel electrode, and a fourth grayscale pixel electrode.
